(19) United States
(12) Patent Application Publication
(10) Pub. No.: US 2025/0239009 A1
(43) Pub. Date: Jul. 24, 2025

(54) REAL TIME, RESOURCE EFFICIENT VIRTUAL REPRESENTATION GENERATION FOR A LOCATION

(71) Applicant: YEMBO, INC., San Diego, CA (US)

(72) Inventors: Hunter BLANTON, San Diego, CA (US); Maciej HALBER, San Diego, CA (US); Janpreet SINGH, San Diego, CA (US); Marc EDER, San Diego, CA (US); Kyle BABINOWICH, San Diego, CA (US)

(21) Appl. No.: 18/887,391

(22) Filed: Sep. 17, 2024

Related U.S. Application Data
(60) Provisional application No. 63/623,127, filed on Jan. 19, 2024.

(51) Int. Cl. G06T 17/00; G06T 7/50

(52) U.S. Cl. CPC G06T 17/00; G06T 7/50; G06T 2207/10016

(57) ABSTRACT

Resource-efficient systems, methods, and software to estimate the geometry of indoor space(s) (e.g., a location) and render a model of the indoor space(s) to a user in real time natively on mobile smartphones is described. Lightweight neural networks are used to estimate depths for each frame in received video data of the location, and a surfel representation is used to fuse location depth information into a geometric representation. Detecting when a user has entered a new room based on the geometric representation in real time is also described, and the resulting ability to create full floor scans where each room is fused together and labeled during a scan.

### FIELD OF THE DISCLOSURE

This disclosure relates to systems, methods, and software for providing artificial intelligence based virtual representations of a location enriched with spatially localized details.

### BACKGROUND

Many applications in the home services industry rely on an accurate understanding of indoor environments (a location). Typically, this information is obtained by sending an individual onsite to take tape or laser measurements and manually drawing out a floor plan schematic. This process requires training for the onsite individual and coordination with the homeowner to ensure that the space is available for measurements. Moreover, multiple visits may be required if the scope of work changes.

Some attempts to expedite this manual process have created automated solutions for the trained onsite visitor or even interfaces for homeowners themselves to take the required measurements. However, these solutions either require expensive specialized hardware, like active depth sensors, or use resource-intensive algorithms that must be run on powerful hardware, which provides limited feedback to the user as to whether they are doing the job correctly. As a result, the processes still require considerable user training, and/or have other disadvantages.

### SUMMARY

Resource-efficient systems, methods, and software to estimate the geometry and semantics of indoor spaces (e.g., a location) natively on hand-held computing devices (e.g., mobile smartphones) is described. Lightweight neural networks are used to estimate depths for each frame in received video data of the location, and a surfel representation is used to fuse location depth information into a geometric representation (e.g., a 3 dimensional (3D) model). Additionally, lightweight neural networks may be used to estimate semantic information about the location, such as identifying layout components like rooms, walls, doors, floors, and ceilings as well as furniture and contents, such as sofas, beds, refrigerators, etc. All of this information is stored in a 3D virtual representation that may include 2D floor plans and/or 3D labeled bounding boxes as well as a 3D model with geometry, semantic, and/or color information.

Some aspects of the present disclosure relate to resource efficient computing systems, methods, and software configured to run on a camera enabled hand-held computing device. The systems, methods, and software are configured to determine geometry information, semantic information, and/or other information for a virtual representation of a location in real time, with spatially localized information of elements within the location being embedded in the virtual representation. Machine-readable instructions are configured to be executed by one or more hardware processors to facilitate receiving video data of the location. The video data is generated via a camera (e.g., of the hand-held computing device). The video data may be captured by a mobile hand-held computing device associated with a user and transmitted to the one or more hardware processors without user interaction (i.e., within the hand-held computing device itself-from the camera of the device to the one or more hardware processors of the device, without any uploading, downloading, etc.). Receiving the video data of the location comprises receiving a real time video stream of the location.

The video data comprises a plurality of successive frames. Depth information is determined, with a depth estimation module, for each of the plurality of successive frames of the video data. The depth information is aggregated, with a reconstruction and rendering module, using surfels, for each of the plurality of successive frames of video data to generate a 3-dimensional (3D) model of the location and contents therein. The 3D model is rendered in real time for display on the hand-held computing device (e.g., rendering to a user is separate from reconstruction-not only is a 3D model built in real time on a smartphone (for example), but it is also rendered it to the user in real time). In some embodiments, semantic information may be determined, with a segmentation module, about the location based on the video data. The semantic information may indicate presence and/or location of components and/or contents of the location. A virtual representation of the location is generated, based on the 3D model, the semantic information, and/or other information, by annotating the 3D model with spatially localized data associated with (in some embodiments, the components and/or contents) of the location. Generating the virtual representation comprises substantially continuously generating or updating the 3D model based on the real time video stream of the location, as the real time video stream is received.

In some embodiments, the components of the location comprise a layout, rooms, walls, doors, windows, ceilings, floors, openings, and/or other components. In some embodiments, the contents of the location comprise furniture, wall hangings, personal items (e.g., books, papers, toys, etc.), appliances, and/or other contents.

In some embodiments, the spatially localized data comprises bounding boxes associated with the components and/or contents of the location; dimensional information associated with the components and/or contents of the location; color information associated with the components and/or contents of the location; geometric properties of the components and/or contents of the location; material specifications associated with the components and/or contents of the location; a condition of the components and/or contents of the location; audio, visual, or natural language notes; metadata associated with the components and/or contents of the location; and/or other information.

In some embodiments, the depth estimation module is configured to determine the depth information for each of the plurality of successive frames of the video data at a rate sufficient for real time virtual representation generation. The depth estimation module is configured to use minimally sufficient computing resources, using cost volume stereo depth estimation and one or more convolution neural networks (CNNs) to estimate full frame metric depth.

A cost volume is constructed using a set of reference keyframes that are selected based on a relative pose metric to select useful nearby images in the plurality of successive frames of the video data. A rolling buffer of reference keyframes is maintained in memory, with a number of the reference frames used for constructing the cost volume being variable and/or dynamic. The cost volume is determined using a parallel algorithm. An input image (e.g., included in and/or comprising a frame of the video data) and the cost volume are passed through a CNN to produce dense metric depth. The CNN uses an efficiently parameterized backbone for real time inference.

In some embodiments, the cost volume is a 3D volume that indicates cost for a given voxel at a specific depth in terms of energy minimization or maximization. A cost at each voxel is determined for potentially multiple images in the plurality of successive frames, and a sum is used as a final cost volume.

In some embodiments, the rolling buffer of reference keyframes is maintained in memory as the video data of the location is received, and each keyframe comprises information needed for downstream processing including an original image, features extracted from the efficiently parameterized CNN backbone, a camera pose, camera intrinsics, a frame identification, and/or a keyframe identification. Each incoming frame is compared to previous keyframes in the buffer to determine if there has been sufficient motion to necessitate a new keyframe; a relative translation and orientation of each incoming frame and an immediately previous keyframe is determined and used to determine a combined pose distance; and a new keyframe is added to the buffer if the combined pose distance breaches a threshold value.

In some embodiments, for each reference keyframe used to construct the cost volume, a combined pose distance is determined as a function of relative translation and rotation between an incoming frame and a reference keyframe; a list of frames that satisfy sufficient motion constraints is obtained; the list is ordered based on camera translation and rotation; a number of reference keyframes is extracted from the ordered list; and for each reference keyframe, a cost volume is determined relative to an incoming frame and cost volumes are summed to produce the final cost volume.

In some embodiments, the depth information is determined by providing an input image frame and the cost volume to the CNN, which outputs a dense metric depth map. The CNN may comprise U-Net encoder/decoder architecture with an efficiently parameterized backbone and skip connections. The CNN may be trained on a large dataset of indoor room scans using a variety of geometric loss functions on ground truth depth measurements.

In some embodiments, the depth estimation module is configured to determine a depth map comprising multiple depth values for each pixel representing visible and occluded surfaces along a camera ray.

In some embodiments, the reconstruction and rendering module is configured to utilize a triangle rasterization pipeline compatible with hardware available on the hand-held computing device to generate the 3D model of the location and contents therein. For each surfel, the reconstruction and rendering module is configured to generate a canonical triangle, and use associated data to place a surfel in three dimensional space. In some embodiments, the reconstruction and rendering module is configured such that newly received video data is continuously fused with the 3D model by: generating new corresponding surfels; fusing the new corresponding surfels with existing surfels; and removing existing surfels heuristically.

In some embodiments, the segmentation module is configured to identify components and/or contents of the location by a semantically trained machine learning model. The semantically trained machine learning model is configured to perform semantic or instance segmentation and/or 3D object detection and localization of each object in an input frame of the video data. In some embodiments, the semantically trained machine learning model comprises a neural network configured to perform two dimensional (2D) segmentation for frames in the video data. In some embodiments, the neural network comprises a feature extractor configured to use minimally sufficient computing resources on the hand-held computing device and a Feature Pyramid Network-based decoder.

In some embodiments, the segmentation module is configured to determine a 3D segmented mesh using the 2D segmentation by associating a semantic class of pixels in the frames of video data to respective surfels by back-projecting the pixels to surfels using a camera pose matrix. The frames of the video data may be streaming in real time. Based on hardware of the hand-held computing device, neural network prediction frequency is dynamically adjusted to manage a load on the one or more hardware processors. As the 2D segmentation is occurring in real time, semantic classes of surfels coming from consecutive 2D segmentations are aggregated, and the most frequently occurring class is determined to be a surfel class.

In some embodiments, a plane module is used to generate (or help generate) the 3D model. The plane module is configured to: detect planes from (large) planar regions in a depth map provided through depth estimation and/or direct sensor measurement; merge new plane detections into the 3D model in real time; use plane information to impose heuristics about location shapes to enhance the 3D model; use planar surfaces to enhance pose accuracy; use planes to estimate geometry of relatively distant or difficult surfaces to detect at the location; use bounded plane estimates determined from each frame in the video data to grow location boundary surfaces in real time, and/or perform other operations.

In some embodiments, a floor plan module is used to generate a floor plan of the location using lines in the 3D model. The lines are determined based on a bird's eye view projection of a reconstructed 3D semantic point cloud. The 3D semantic point cloud is reconstructed using a class-wise point density map of a bird's eye view mesh, generated by axis-aligning the mesh with a floor plane normal, orthogonally projecting the mesh from a top of the mesh, translating and scaling the point cloud, and determining a density map for the point cloud by slicing the point cloud at different Z values. Different floor instances are determined based on the density map; and boundary points are determined based on the different floor instances, which are used to determine line segments defining the floor plan.

In some embodiments, a detection model may be applied to each frame in the video data during a scan. Output at each frame comprises a set of 2D labeled bounding boxes for each frame. These detections are matched across frames using a tracking module which may use camera poses and feature tracking to form tracks for each content of the location, thereby grouping detections of the same content from multiple views into a single set of detections. Different viewpoints and corresponding detection boxes for the same content are fused to create a unified 3D representation.

In some embodiments, an inside/outside module is configured such that the video data of the location is received room by room and used to reconstruct multiple rooms in a common coordinate space. The 3D model and/or the virtual representation of the location may include all rooms on at least one floor of the location, for example. This may include determining whether a user has exited a room such that, responsive to conclusion of a scan of a room, a bounding rectangle is determined based on generated surfels, and the bounding rectangle is divided into square bins and surfel normals that fall into each bin are accumulated. An average normal vector for each bin is determined, with bin dimensions being an implementation-dependent variable. Per-bin segments are determined for bins that accumulated more than a threshold number of surfels, where the threshold number of surfels is also an implementation-dependent variable. A vector orthogonal to the average normal vector is determined, a bin center is determined, and segment endpoints at predefined distances from the bin center are determined on opposite sides of the bin center, with the predefined distances being related to the bin dimensions, and. A current user location comprising a query point is determined. The user is determined to be outside the room if the query point is outside of the bounding rectangle, or per-bin segments are used to determine generalized a winding number, which is used as an indicator of whether the user is inside or outside the room. As the user moves from room to room, the virtual representation is updated room by room.

### BRIEF DESCRIPTION OF THE DRAWINGS

FIG. 1 illustrates a system for estimating the geometry and semantics of indoor spaces (e.g., a location) natively on hand-held computing devices (e.g., mobile smartphones), in accordance with one or more embodiments.

FIG. 2 illustrates generating, for each surfel, a canonical triangle, and using associated data to place a surfel in three dimensional space, in accordance with one or more embodiments.

FIG. 3 illustrates applying a similarity transformation (X) is to the three vertices of the canonical triangle (FIG. 2), in accordance with one or more embodiments.

FIG. 4 illustrates a reconstruction flow, in accordance with one or more embodiments.

FIG. 5 illustrates a density map image, in accordance with one or more embodiments.

FIG. 6 is a diagram that illustrates an exemplary computing system in accordance with embodiments of the present system.

FIG. 7 is a flowchart that illustrates a process for estimating the geometry and semantics of indoor spaces (e.g., a location) natively on hand-held computing devices (e.g., mobile smartphones), in accordance with one or more embodiments.

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION

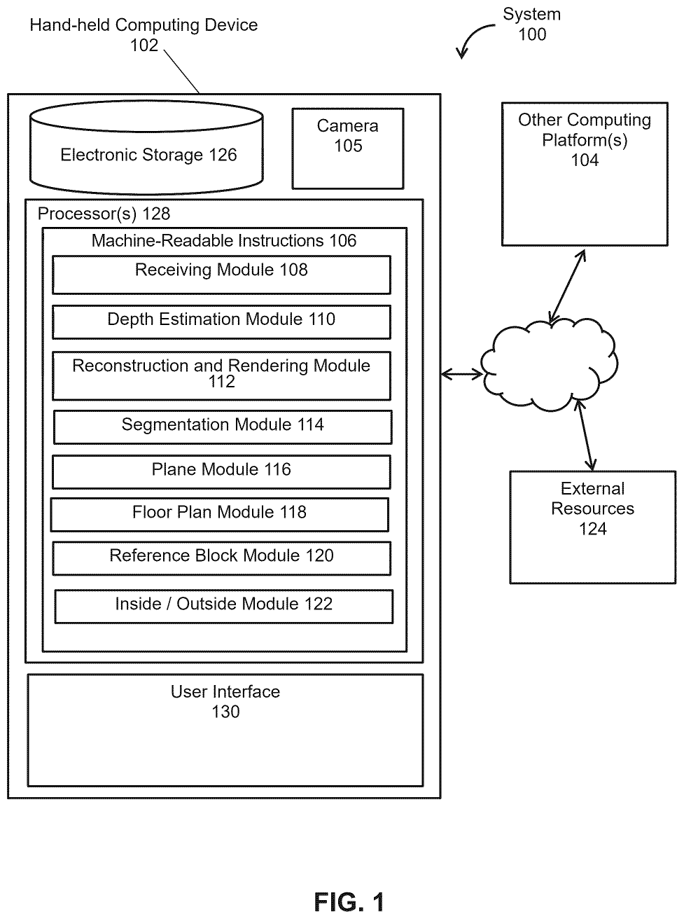

FIG. 1 illustrates a simplified and more user friendly system 100 (compared to prior systems as described above) for capturing videos of a location, and generating accurate virtual representations based on the captured videos. System 100 is configured to use the videos to automatically generate virtual representations. Advantageously, system 100 is configured to estimate the geometry and semantics of indoor spaces (e.g., a location) natively on hand-held computing devices (e.g., mobile smartphones) in real time (or near real time). As described above, system 100 enables this functionality because lightweight neural networks are used to estimate depths for each frame in received video data of the location, and a surfel representation is used to fuse location depth information into a geometric representation (e.g., a 3 dimensional (3D) model). Additionally, in some embodiments, lightweight neural networks may be used to estimate semantic information about the location, such as identifying layout components like walls, doors, floors, and ceilings as well as furniture and contents, such as sofas, beds, refrigerators, etc.

FIG. 1 illustrates a hand-held computing device 102. Device 102 may be a smartphone, for example, and/or another hand-held computing device. Device 102 may be configured to communicate with one or more other computing platforms 104, external resources 124, and/or other systems via a network (as shown in FIG. 1) and/or other wireless or wired connections. Other computing platforms 104 may include one or more external servers, other hand-held computing devices associated with other users, and/or other computing platforms. External resources 124 may include sources of information (e.g., databases) outside of system 100, websites, the electronic systems of entities participating with system 100 (e.g., home services providers), etc., Users may access system 100 via device 102. For example, a user may access system 100 through user interface 130 of device 102. User interface 130 may include a touch screen and/or other components configured to provide information to, and/or receive information from, a user. As described below, system 100 may be configured to present a virtual representation of a location to a user in real time through a display (e.g., the touch screen) of user interface 130.

Device 102 may include one or more processors 128 configured to execute machine-readable instructions 106. Machine-readable instructions 106 may cause execution of an application (or app) by one or more processors 128 running on device 102 to provide the functionality described herein. Machine-readable instructions 106 may include a receiving module 108, a depth estimation module 110, a reconstruction and rendering module 112, a segmentation module 114, a plane module 116, a floor plan module 118, a reference block module 120, an inside/outside module 122, and/or other modules.

Processor(s) 128 are configured to provide information processing capabilities in system 100. Although processor 128 is shown in FIG. 1 as a single entity, this is for illustrative purposes only. In some embodiments, processor 128 may comprise a plurality of processing units. These processing units may be physically located within the same device (e.g., hand-held computing device 102), or processor 128 may represent processing functionality of a plurality of devices operating in coordination.

As shown in FIG. 1, processor 128 is configured to execute one or more computer program modules (as described above). The computer program modules may comprise software programs and/or algorithms coded and/or otherwise embedded in processor 128, for example. Processor 128 may be configured to execute modules 108, 110, 112, 114, 116, 118, 120, and/or 122 by software; hardware; firmware; some combination of software, hardware, and/or firmware; and/or other mechanisms for configuring processing capabilities on processor 128.

It should be appreciated that although modules 108, 110, 112, 114, 116, 118, 120, and 122 are illustrated in FIG. 1 as being co-located within a single processing unit, in embodiments in which processor 128 comprises multiple processing units, one or more of modules 108, 110, 112, 114, 116, 118, 120, and/or 122 may be located remotely from the other components. The description of the functionality provided by the different modules 108, 110, 112, 114, 116, 118, 120, and/or 122 described below is for illustrative purposes, and is not intended to be limiting, as any of modules 108, 110, 112, 114, 116, 118, 120, and/or 122 may provide more or less functionality than is described. For example, one or more of modules 108, 110, 112, 114, 116, 118, 120, and/or 122 may be eliminated. Some or all of a given module's functionality (or none of its functionality if eliminated) may be provided by other modules 108, 110, 112, 114, 116, 118, 120, and/or 122. As another example, processor 128 may be configured to execute one or more additional modules that may perform some or all of the functionality attributed below to one of modules 108, 110, 112, 114, 116, 118, 120, and/or 122.

Receiving module 108 may be configured to receive video data of a location. The video data comprises a plurality of successive frames. Each frame may comprise a successive image of the location, for example. The location may be and/or include an indoor portion (e.g., a room) of a house, apartment, building, and/or other structure. In some embodiments, system 100 and/or the principles described herein may be applied to an outdoor portion (e.g., walls, a patio, etc.) of a location. The video data may be generated as part of a scan of the location with camera 105 of device 102, for example. Camera 105 may be a video camera, a still camera capable of taking several consecutive pictures, and/or other cameras. Camera 105 may be similar to and/or the same as a camera that is typically included in a smartphone, for example. In some embodiments, the scanning may be performed by one or more of camera 105, a computer vision device, and/or other scanners. In some embodiments, the scan may be performed by a user associated with device 102. The video data may be transmitted to module 108 (the one or more hardware processors) from camera 105 without user interaction. Receiving the video data of the location comprises receiving a real time video stream of the location.

Depth estimation module 110 is configured to determine depth information for each of the plurality of successive frames of the video data. Depth estimation module 110 is configured to determine the depth information for each of the plurality of successive frames of the video data at a rate sufficient for real time virtual representation generation. Depth estimation module 110 is configured to use minimally sufficient computing resources, using cost volume stereo depth estimation and one or more convolution neural networks (CNNs) to estimate full frame metric depth.

A neural network may be trained (i.e., whose parameters are determined) using a set of training data. The training data may include a set of training samples. Each sample may be a pair comprising an input object (typically a vector, which may be called a feature vector) and a desired output value (also called the supervisory signal). Training inputs may be video images, for example. A training algorithm analyzes the training data and adjusts the behavior of the neural network by adjusting the parameters (e.g., weights of one or more layers) of the neural network based on the training data. A feature vector is an n-dimensional vector of numerical features that represent some object (e.g., an image of a room with various components and/or content to be modeled). The vector space associated with these vectors is often called the feature space. After training, the neural network may be used for making predictions using new samples (e.g., video images of different rooms).

A cost volume is constructed using a set of reference keyframes that are selected based on a relative pose metric to select useful nearby images in the plurality of successive frames of the video data. Relative pose is defined as the 3D rotation and translation of the camera between pairs of frames. A rolling buffer of reference keyframes is maintained in memory (e.g., electronic storage 126), with a number of the reference frames used for constructing the cost volume being variable and/or dynamic. The cost volume is determined for each pixel in parallel by processor(s) 128. An input image (e.g., included in and/or comprising a frame of the video data) and the cost volume are passed through a CNN to produce dense metric depth. The CNN uses an efficiently parameterized backbone for real time inference (such that system 100 may be compatible with many different smartphones with varying processing power, for example). A CNN with an efficiently parameterized backbone may comprise a neural network architected to use a minimal number of model parameters (e.g., model weights) required for a task (more parameters means heavier memory and computing requirements). A CNN with an efficiently parameterized backbone is configured to reduce the number of parameters required by the network, while maintaining some metric on output performance.

In some embodiments, the cost volume is a 3D volume that indicates cost for a given voxel at a specific depth in terms of energy minimization or maximization. A cost at each voxel is determined for potentially multiple images in the plurality of successive frames, and a sum is used as a final cost volume. For example, each voxel may be indexed as (i,j,k) with i∈[0, W], j∈[0, H], k∈[0, D] where W is the width of an image, H is the height of the image, and D is the number of depths sampled. The cost for voxel (i,j,k) is computed for a source image A and a reference image B using the relative transformation matrix T^{B}_{A} and camera intrinsics matrices K_{A} and K_{B} as follows: X_{A}=D (K)*K_{A}⁻¹*vec3(i,j, 1); X_{B}=K_{B}*T^{B}_{A}*X_{A}; Cost(i,j,k)=dist(A(proj(X_{B}), (i,j)); where D(k) is a mapping from voxel slice to metric depth value, proj is the projection mapping from a 3D coordinate into the image plane, and dist( ) is any distance metric (e.g., cosine similarity, Euclidean distance, absolute distance, etc.). The cost at each voxel is computed for potentially multiple images and the sum is used as the final cost for the sample.

In some embodiments, the rolling buffer of reference keyframes is maintained in memory as the video data of the location is received, and each keyframe comprises information needed for downstream processing including an original image, features extracted from the efficiently parameterized CNN backbone, a camera pose, camera intrinsics, a frame identification, and/or a keyframe identification. Each incoming frame is compared to previous keyframes in the buffer to determine if there has been sufficient motion to necessitate a new keyframe. A relative translation and orientation of each incoming frame and an immediately previous keyframe is determined and used to determine a combined pose distance; and a new keyframe is added to the buffer if the combined pose distance breaches a threshold value. The threshold value may be determined based on implementation specifics. The threshold value is configured to provide a minimal number of frames to ensure efficient performance on a computing resource constrained device like a smartphone. However, the threshold value is also configured to ensure sufficient movement between frames, so there is a baseline between camera poses while still maintaining field of view overlap between frames, for example.

In some embodiments, for each reference keyframe used to construct the cost volume, a combined pose distance is determined as a function of relative translation and rotation between an incoming frame and a reference keyframe; a list of frames that satisfy sufficient motion constraints are obtained; the listed is ordered based on camera translation and rotation; a number of reference keyframes is extracted from the ordered list; and for each reference keyframe, a cost volume is determined relative to an incoming frame and cost volumes are summed to produce the final cost volume. For example, when an incoming video frame is used for depth estimation, a 3D cost volume is determined to process the frame through the depth estimation CNN. To build the cost volume, nearby frames are selected that will be informative for cost determination. Nearby frames are retrieved from the keyframe buffer to use as reference frames for the cost volume. For each frame in the cost volume, the combined pose distance as a function of relative translation and rotation between the incoming frame and the keyframe are determined. A list of all frames that satisfy sufficient motion constraints (associated with a user's movement of device 102 and camera 105 for example) are retrieved. The list is ordered by camera translation and rotation. The top K keyframes are extracted from the ordered list. It is possible to retrieve a variable number of keyframes up to some predefined maximum. For each keyframe, a cost volume is determined relative to an incoming source image (video frame) and all cost volumes are summed to produce the final cost volume for this sample.

In some embodiments, the depth information is determined by providing an input image frame and the cost volume to the CNN, which outputs a dense metric depth map. The CNN may comprise U-Net encoder/decoder architecture with the efficiently parameterized backbone and skip connections. The efficiently parameterized backbone may comprise ResNet18, MobileNetv2, EfficientNet B1, MNasNet, etc. The CNN may be trained on a large dataset of indoor room scans using a variety of geometric loss functions on ground truth depth measurements.

In some embodiments, depth estimation module 110 is configured to determine a depth map comprising multiple depth values for each pixel representing visible and occluded surfaces along a camera ray. For example, depth estimation as described above facilitates reconstruction of the parts of the location (e.g., a room) that are visible to camera 105. To get a more complete reconstruction of the room in terms of wall, floor, and ceiling, another depth map may be predicted that represents the room depth, or the depth if there were no objects occluding the boundary of the room. This allows for segmentation of components and contents of the room, and improved room completeness for downstream tasks.

In some embodiments, the representation of the location is a generalization of a point-cloud data structure, where each point stores the following attributes: position p, normal n, radius r, color c, age a, and weight w. In some embodiments, this list can be extended with: semantic class s, spherical harmonic coefficients [S], and object ID o. These points comprise surfels (Surface Elements). Reconstruction and rendering module 112 is configured to aggregate the depth information using surfels for each of the plurality of successive frames of video data, to generate a 3-dimensional (3D) model of the location and contents therein.

Given a 3D model of the location stored as a set of surfels storing aforementioned attributes, rendering is configured to present data to the user (e.g., via user interface 130) at interactive rates (e.g., in real time). In some embodiments, reconstruction and rendering module 112 is configured to utilize a triangle rasterization pipeline compatible with hardware available on hand-held computing device 102 to generate the 3D model of the location and contents therein. In some embodiments, reconstruction and rendering module 112 is configured such that newly received video data is continuously fused with the 3D model by: generating new corresponding surfels; fusing the new corresponding surfels with existing surfels; and removing existing surfels heuristically, such as based on confidence, support, weight, and/or age.

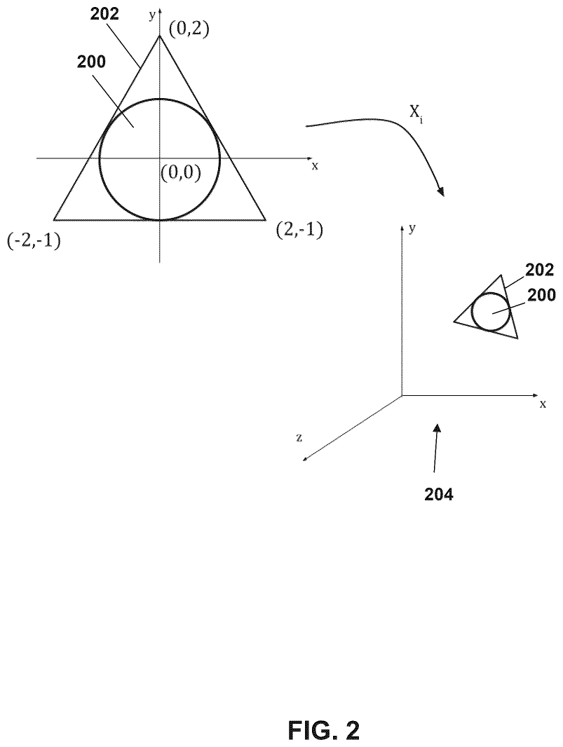

As shown in FIG. 2, for each surfel 200, reconstruction and rendering module 112 (FIG. 1) is configured to generate a canonical triangle 202, and use associated data to place each surfel 200 in three dimensional space 204. A similarity transformation X is applied to the three vertices of the canonical triangle.

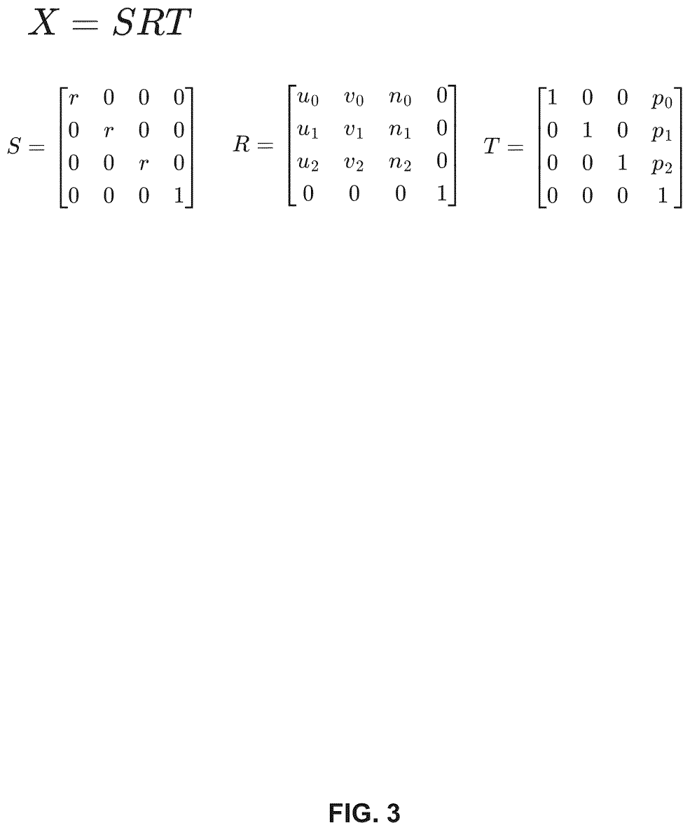

As shown in FIG. 3, transformation X comprises three components: scale matrix S, rotation matrix R, and translation matrix T. Scale Matrix S is a 4×4 matrix, with non-zero elements on a diagonal, determined using a radius attribute [radius, radius, radius, 1.0]. Rotation Matrix R is a 4×4 matrix representing a member of Special Orthogonal group 3 (SO(3)). Rotation matrix R is determined from the normal vector, where first an arbitrary vector u orthogonal to normal n is found. To find a last vector v a cross product between u and v is used and all vectors are normalized to obtain a valid rotation matrix. Translation Matrix T is a 4×4 matrix with a last column representing translation from the origin (see FIG. 2) to a location p of the surfel. The final transformation matrix X is the result of multiplying the above components X=SRT. Transformation Xi (FIG. 2) is determined for each surfel and applied to the canonical triangle to determine a set of triangles that can be rasterized using a rendering pipeline.

To present the triangles as disks, a fragment shader (functionally provided by one or more processors 128) may be used to conditionally discard some pixels occupied by a rasterized triangle, for example. To achieve this, unmodified vertex locations from the canonical triangle are passed in, which were constructed specifically such that the triangle contains a circle of unit radius. As such, surfels that lie outside the disks can be discarded, allowing presentation of a circle to the user, improving the visual quality, among other advantages.

To render large amounts of surfels efficiently, instanced rendering is utilized, where there is 1:1 mapping between surfel data and an instance. The canonical triangle data is shared among all the surfels, and is modified on a per-instance basis to generate and render unique triangles. This setup allows rendering all surfels using a single draw call. In some embodiments, more advanced instancing techniques can be used, such as merge instancing (for example, see extension://efaidnbmnnnibpcajpcglclefindmkaj/https://www.humus.name/Articles/Persson_GraphicsGemsForGames.pdf).

Returning to FIG. 1, in some embodiments, rendering performance can be improved by introducing spatial organization to the surfels, by binning them into three dimensional boxes (surfel is assigned to a box if it falls within it). Once surfels are organized system 100 can test if a box overlaps with a camera (camera 105) frustum. If this test fails, surfels within the box will not be rendered, and can be skipped when rendering. Under certain conditions this can dramatically reduce the amount of data that needs to be rendered by reconstruction and rendering module 112, leading to improved performance and device 102 battery life.

Data can be presented to users in a variety of ways (via user interface 130). For example, a first person view may be used where a virtual camera is placed in an estimated position of the physical device 102 in the location and a surfel point-cloud may be rendered from this position. This allows overlaying the camera feed with the surfels, informing users what parts of the scene have been captured. A third person view may be used where the virtual camera may be placed slightly behind the estimated position of the physical device 102. This gives a wider field of view, allowing a user to visualize a larger part of the scene in the location. A bird's eye view may be used where the user is allowed to look at the scanned location from a top perspective and explore the space freely using orbit camera control, for example.

The goal of the reconstruction is to build a three dimensional model of an indoor space (e.g., a location) from an input stream of (color) video image frames, depth images, and camera parameters (e.g., intrinsics and pose). Reconstruction by reconstruction and rendering module 112 is performed in an online fashion where new data is continuously fused with the 3D model. In some embodiments, the rendering methodology described herein is used to provide real time feedback to a user on the progress of reconstruction. As described above, rendering (e.g., to a user) may be separate from reconstruction. Reconstruction and rendering module 112 may be configured for building a 3D model in real time on the smartphone, and also rendering it (to the user) in real time on that same smartphone (e.g., an example of a resource limited computing device, as described herein).

Each time new video data frame data is received (which has color, depth, and camera data), the following operations may be performed:
Surfel Creation—this step converts input color, depth and camera data to surfels, stored in camera space (CS). The position p of the surfel is determined by back-projecting an associated pixel, normal n using finite differences, and radius r using camera intrinsics such that the projected size of the surface is approximately 1 pixel. The surfel's age a is initialized to be 0, and the weight w to 1. The result of this step is a set of surfels S_{d}.
Surfel Fusion—Given the surfels S_{d} determined from latest frame data and the map surfels Sₘ (or surfel map) determined in previous iterations, S_{d} is to be fused with Sₘ in the regions where the two overlap. This is important in order to keep the amount of data manageable for a device such as device 102. Additionally, the surfel fusion acts as a simple filter, facilitating the merging multiple observations into a single estimate of a surfel's parameters. To perform the fusion, S_{d} and Sₘ are rendered into a two channel image, S_{d} in channel 0, and Sₘ in channel 1. Note that at this stage only the surfel's position p is used and both Sₘ and S_{d} are rendered as points. The region around projection of each surfel from S_{d} is analyzed to find the best candidate from Sₘ. If no suitable candidate is found a surfel from S_{d} is added to Sₘ. Otherwise, the two surfels are fused, combining them into one, and updating the attributes, other than w and a, using a running weighted average. Weight w is the sum of weights of the two surfels and age a is increased by 1. In some embodiments, the surfel's age, a, can be incremented by a value that is a function of the depth estimation frequency. In some embodiments, the weight of surfels in the set Sₘ can be decreased, if they are found to violate a free-space assumption. Violating the free space assumption means that a surfel has been placed somewhere that should be empty space. This effectively means the system is configured to decrease the confidence that a surfel has been correctly positioned in the model if there is competing support (e.g. from a different view and depth map) implying a surfel's position should actually be empty space.
Surfel Cleanup-Some surfels generated during the surfel creation stage are noisy measurements that should not be included in the final reconstruction. To remove such outliers an iteration over all surfels in Sₘ is performed, to analyze their weight and age. If a surfel is old (high age a) and has not been fused with other surfels (low weight w), confidence is high that it is an outlier and can be removed from Sₘ.

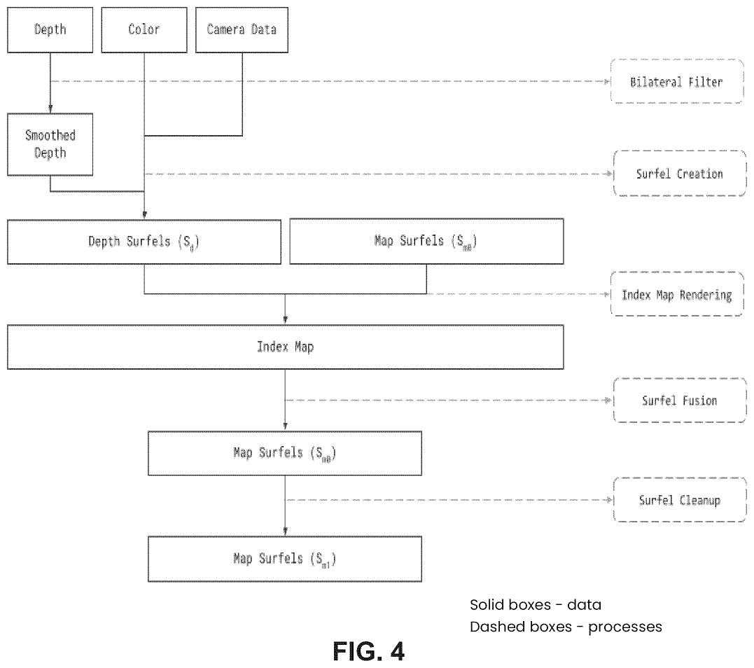

As such, reconstruction and rendering module 112 performs an iterative process, which incorporates new measurements to continuously grow and improve the 3D model. In some embodiments, a double buffering approach can be utilized, where Sₘ₀ (surfel map from previous frame) is rendered while at the same time determining the Sₘ₁ (surfel map from the next frame) using some or all of the steps described above. Additionally, a double buffering approach may be required to efficiently implement the surfel cleanup operations, using techniques like stream compression. See the example flowgraph for reconstruction in FIG. 4.

In some embodiments, reconstruction and rendering module 112 may perform an additional surfel binning operation configured to reorder contents of Sₘ (a surfel map), such that the consecutive surfels in the devices memory fall into the same three dimensional box. This facilitates implementation of the frustum culling technique described herein. In some embodiments, reconstruction and rendering module 112 may perform an additional depth smoothing operation, configured to apply a bilateral filter to an input depth map to reduce measurement/estimation noise. System 100 intrinsically relies on the quality of poses obtained from VIO systems like ARKit or ARCore.

To improve system 100 robustness, some embodiments can extend reconstruction operations with frontend visual refinement, where each time a new frame arrives, its pose is tested by reconstruction and rendering module 112 against most recent keyframes (see depth estimation above). The pose is optimized to minimize the reprojection error between a new image and keyframes. Frontend structural refinements may be performed, where each time a new frame arrives, its back projected surfel data can be tested against extracted structural data (see progressive plane growing and floor plan operations described herein). The residual is formed as a violation of physical constraints (i.e. estimated geometry intersects estimated room structure) and a new pose is optimized to minimize the residual. In some embodiments, a SLAM (simultaneous localization and mapping) backend may be utilized, which improves camera poses by means of non-linear optimization where the same position in the indoor environment is visited multiple times by a user during a scan. Once a pose update is computed, a surfel's attributes in Sₘ are updated. In some embodiments, this is achieved using a deformation graph. This technique is similar to how vertex positions of a 3D mesh are modified using skinned mesh animation, for example.

In some embodiments, segmentation module 114 is configured to segment the video data. (Note that, as described above, segmentation module 114 may not be included in system 100 at all, and/or some or all of its functionality may be performed by other modules.) Segmentation module 114 may be configured to estimate different classes of components and/or contents in the location (e.g., an indoor environment), such as walls, floors, doors, windows, etc., Image data is leveraged to first extract pixel labels in 2D, and label aggregation is used to estimate the vertex labels for the point cloud (described herein). Segmentation module 114 is configured to determine semantic information about the location based on the video data and/or other information. The semantic information indicates presence and/or location of components and/or contents of the location. In some embodiments, the components of the location comprise a layout, walls, doors, windows, ceilings, floors, openings, and/or other components. In some embodiments, the contents of the location comprise furniture, wall hangings, personal items (e.g., books, papers, toys, etc.), appliances, and/or other contents.

In some embodiments, segmentation module 114 is configured to identify components and/or contents of the location by a semantically trained machine learning model. The semantically trained machine learning model may be configured to perform semantic or instance segmentation and/or 3D object detection and localization of each object in an input frame of the video data. In some embodiments, the semantically trained machine learning model comprises a neural network configured to perform two dimensional (2D) segmentation for frames in the video data. In some embodiments, the neural network comprises a feature extractor configured to use minimally sufficient computing resources on the hand-held computing device and a Feature Pyramid Network-based decoder.

For example, the feature extractor may comprise Resnet18, MobileNetv2, etc., followed by the Feature Pyramid Network-based decoder. The neural network may be configured to receive an RGB (red green blue) image of size H(image height)×W(image width)×3(RGB channels) taken during a video scan of the location as input and predict a class probability map of size H×W×C (the number of classes). Each pixel may be assigned a probability distribution function with the number of events as C. Hence, a final class can be determined by determining an event (class) that is most probable. The argmax function may be used for this operation, along the last dimension of this class probability map, giving a per-pixel segmentation map of size H×W.

Segmentation (e.g., if performed at all) may be performed either with a dedicated model or through joint training of depth and segmentation decoders using a shared encoder backbone. Segmentation module 114 may use (only) an RGB image as input, or alternatively utilize additional inputs such as poses and depth maps.

In some embodiments, segmentation module 114 is configured to determine a 3D segmented mesh using the 2D segmentation by associating a semantic class of pixels in the frames of video data to respective surfels by back-projecting the pixels to surfels using a camera pose matrix. The frames of the video data may be streaming in real time. Based on hardware of the hand-held computing device, neural network prediction frequency is dynamically adjusted to manage a load on the one or more hardware processors. As the 2D segmentation is occurring in real time, semantic classes of surfels coming from consecutive 2D segmentations are aggregated, and the most frequently occurring class is determined to be a surfel class.

For example, with a segmentation map of an image, a 3D segmented mesh may be determined using 2D segmentation maps. The semantic class of these pixels may be associated with the respective surfels by back-projecting the pixels to surfels using the camera pose matrix. This gives one-to-one mapping between a surfel and a pixel. Note that input RGB images are streaming in real time, and based on the hardware of device 102, the model prediction frequency may be adjusted (increased or decreased) to manage a load on processor(s) 128 appropriately. As the prediction of these 2D segmentation maps is occurring in real time, the semantic classes of surfels coming from consecutive 2D segmentation maps are aggregated. For this aggregation, an array of length C (number of classes) is generated, representing class frequency for each surfel. For this array of length C, the i^{th} element comprises a number of times the model predicted the class of the surfel as i. As the user continues to scan, the most frequently occurring class is used as the surfel class. After the user completes the scan, a semantically segmented 3D mesh is generated. As an alternative to this histogram-based voting approach for aggregating labels, a running median or mean and variance of class labels can be used.

Processor(s) 128 are configured to generate a virtual representation of the location. The virtual representation may be generated based on the 3D model, the semantic information, and/or other information. In some embodiments, the virtual representation may be generated by annotating the 3D model with spatially localized data associated with the components and/or contents of the location. In some embodiments, the spatially localized data comprises bounding boxes associated with the components and/or contents of the location; dimensional information associated with the components and/or contents of the location; color information associated with the components and/or contents of the location; geometric properties of the components and/or contents of the location; material specifications associated with the components and/or contents of the location; a condition of the components and/or contents of the location; audio, visual, or natural language notes; metadata associated with the components and/or contents of the location; and/or other information. Generating the virtual representation comprises substantially continuously generating or updating the 3D model based on the real time video stream of the location, as the real time video stream is received.

Plane module 116 is configured to generate (or help generate) the 3D model. (Note that, as described above, plane module 116 may not be included in system 100 at all, and/or some or all of its functionality may be performed by other modules.) In some embodiments, plane module 116 is configured to: detect planes from (relatively large) planar regions in a depth map provided through depth estimation and/or direct sensor measurement; merge new plane detections into the 3D model in real time; use plane information to impose heuristics about location shapes to enhance the 3D model; use planar surfaces to enhance pose accuracy; use planes to estimate geometry of relatively distant or difficult surfaces to detect at the location; use bounded plane estimates determined from each frame in the video data to grow location boundary surfaces in real time, and/or perform other operations.

For example, plane module 116 (e.g., if present) may be configured to detect planes from (large) planar regions in the depth map (relative to other planar regions in the depth map) provided through depth estimation (as described above), via direct measurement from onboard sensors, and/or by other operations. Plane module 116 may be configured to use the depth and camera 105 intrinsic information to determine per pixel vertices V and normals N, and a binary mask of coplanar pixels. Individual planes are segmented through connected components of the binary mask. The vertices in each plane segmentation are used to determine a plane equation for each plane segmented in a video image frame. Plane module 116 may filter on planes of interest from the segmentation class from the segmentation estimation network. Plane module 116 may be configured to apply a segmentation mask to the planar mask to determine a planar mask on structures such as walls, floors, ceiling, etc. (i.e., components of the location). This is determined in real time during a video stream, for example. Plane IDs are associated with surfels in reconstruction to facilitate visualization and processing downstream.

New plane detections may be merged into the real time reconstruction (of the 3D model and/or virtual representation described above). During fusion, associations between scene planes and incoming image planes are detected based on surfel association. Scene planes (planes already part of the 3D model) and image planes that breach a threshold amount of associations, and whose plane equations breach a threshold of plane similarity, may be merged. Merged planes may be averaged to generate a new plane and all surfels belonging to any of the merged planes are assigned the new plane ID.

The use of plane information may facilitate imposing heuristics about location (e.g., room) shapes to improve reconstruction, for example. In some embodiments, plane module 116 may impose that adjacent planes must meet certain constraints such as walls need to be nearly 90 degrees to floors, adjacent walls should be one of a few common angles, etc. This aids in making the reconstruction and visualization appear more consistent with the true location (e.g., room) geometry.

In some embodiments, plane module 116 may utilize relatively large planar surfaces (compared to other planar surfaces in the location and/or the 3D model) to improve pose accuracy. Planes provide strict constraints on camera poses since the viewed planes must remain static regardless of camera location. This improves pose accuracy over long trajectories and improves reconstruction quality especially in regions with large planar surfaces.

In some embodiments, the use of planes may facilitate estimation of geometry under difficult conditions such as distant walls and ceilings. Depth fusion reconstruction may be noisy in areas of low depth accuracy such as ceilings, which may be too far away for accurate sensor measured depth, as well as too uniform for accurate depth prediction. Planar heuristics about the smoothness of typical ceilings or other common large flat regions that are difficult to measure accurately facilitates modeling of these surfaces with a more reliable plane representation.

In some embodiments, plane module 116 may use bounded plane estimates determined from each video data frame in a scan video to grow boundary surfaces of the 3D model and/or virtual representation of the location (e.g. walls, floors, and ceilings in real time during the scanning process). For example, in these embodiments, plane module 116 may begin with an empty set of bounded 2D plane proposals. As the user scans the location, new bounded plane proposals are formed by estimating planes from the estimated depth maps conditioned on semantic class label predictions. As each new bounded plane is estimated, it is compared to the existing set of bounded planes. If a new bounded plane is coplanar to and intersects with any existing bounded plane, the two planes are merged, and the bounds are expanded to include the new plane and the combined plane's support is updated. If a new bounded plane is coplanar to and intersects multiple existing bounded planes, all planes are combined into a single bounded plane. If a new plane is not coplanar to an existing bounded plane, it is added to the set of bounded plane proposals. After every N new bounded planes, the bounded plane proposal set is searched for non-coplanar intersections in order to identify and track junctures in a piecewise planar environment. Once all frames have completed processing and all detected bounded planes are merged into the bounded plane.

In some embodiments, floor plan module 118 is configured to generate a floor plan of the location using lines in the 3D model. (Note that, as described above, floor plan module 118 may not be included in system 100 at all, and/or some or all of its functionality may be performed by other modules.) The lines may be determined based on a bird's eye view projection of a reconstructed 3D semantic point cloud. In general, floor plan module 118 (e.g., if present) may be configured to preprocess a mesh, followed by projection to an image plane and then floor plan prediction using this image. The 3D semantic point cloud is reconstructed using a class-wise point density map of a bird's eye view mesh, generated by axis-aligning the mesh with a floor plane normal, orthogonally projecting the mesh from a top of the mesh, translating and scaling the point cloud, and determining a density map for the point cloud by slicing the point cloud at different Z values. Different floor instances are determined based on the density map; and boundary points are determined based on the different floor instances, which are used to determine line segments defining the floor plan.

For example, a class-wise point density map of a bird's eye view mesh may be used, as described above. To generate a bird's eye view projection, floor plan module 118 may be configured to axis-align the mesh by aligning the normal of the floor plane with the Z axis. Note that as the segmented point clouds already exist, the floor plan can be determined by performing a principle component analysis (PCA) on floor points. This alignment decreases or eliminates distortion while performing an orthogonal projection of this mesh from the top. Floor plan module 118 may be configured to translate and scale the point cloud such that all vertices are between [0, some given upper limit]. These points are rounded to the nearest integer, giving a pixel value to which the point will be projected. Floor plan module 118 may determine the frequency of points coming in each pixel and divides this frequency by the maximum frequency across all pixels. This gives a density map for the point cloud. Density maps at different Z values may be extracted by slicing the point cloud at a Z value and determining the density map for these sliced point clouds. These density maps of shape (H×W×1) are concatenated to form a single tensor of shape (H×W×S), where H is the height of the tensor, W is the width of the tensor, and S is the number of slices.

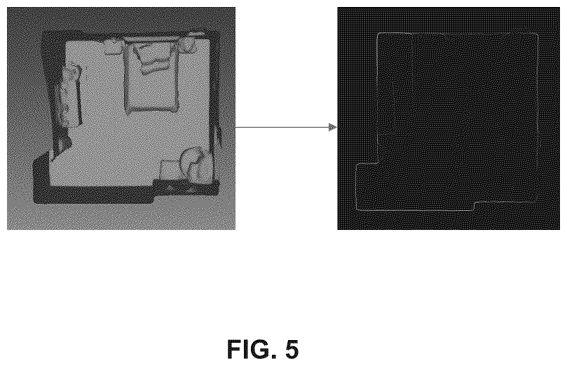

As one possible example of potential functionality of system 100 provided by floor plan module 118 (e.g., which may or may not actually be included in system 100), a density map image for S=1 is presented FIG. 5. FIG. 5 illustrates a scan from a bird's eye view (left side), and a density map from this bird's eye view (right side). Density maps may be augmented with other pointwise information such as semantic labels, for example.

Returning to FIG. 1, floor plan module 118 (e.g., if present) may be configured such that the tensor of size (H×W×S) is used as an input to an instance segmentation model configured to predict different floor instances for a scan. The RTMDet model may be used as the instance segmentation model, as one possible example. This model provides a sufficient trade-off between speed and accuracy and hence is suitable for real time floorplan prediction. Once all floor instances are determined, boundary points of the mask are extracted by extracting its contour. The output of this contour detection gives points in a counterclockwise direction and can be used to make consecutive line segments. As these consecutive line segments may not be of uniform length, that is, some might be short or some might be long, the longer segments are divided such that each segment has a maximum length of 0.05 meters (for example). These segments are merged using connected components, where the connected components are applied based on the segment normal and distance between their centers. To obtain the final floorplan lines, a PCA is run on the endpoints of the segments from connected components, and best-fit lines from these points are determined.

In some embodiments, floor plan module 118 may be configured such that these line segments are used to divide the whole floor plane into sections (e.g., a 2D lattice). Floor plan module 118 may be configured to determine boundary segments by determining whether a segment is inside or outside by determining a winding number of the curve formed by the segments. Once all boundary segments are obtained, the floor plan may be determined by joining boundary edges, for example.

Reference block module 120 is configured such that a detection model may be applied to each frame in the video data during a scan. (Note that, as described above, reference block module 120 may not be included in system 100 at all, and/or some or all of its functionality may be performed by other modules.) Output at each frame may comprise a set of 2D labeled bounding boxes for each frame. These detections may be matched across frames using a tracking module based on camera poses and feature tracking to form tracks for each content of the location, thereby grouping detections of the same content from multiple views into a single set of detections. Different viewpoints and corresponding detection boxes for the same content may be fused to create a unified 3D representation.

For example, reference block module 120 may receive the video data of the location (e.g., an indoor environment) and run a YOLOv5 object detector trained on a detection dataset (e.g., as described above). After determining detections, reference block module 120 may utilize an advanced Kalman Filter (KF), for example, to account for state correction after occlusion that results in more accurate state estimation. Reference block module 120 may use a RelD model that is trained for fine grained semantic understanding of multiple visual object categories. These reid embeddings may be combined for matched track ids using an Exponential Moving Average (EMA), for example, which is selectively biased towards high quality detections. Reference block module 120 may blend motion and visual costs along with a text embedding cost that infers semantic relationships between detector class labels using a BLIP2 model, for example. A Hungarian matching algorithm may be run on this cost to estimate ideal detection/track matches, as one example.

These operations for output tracking identifications may be further refined using a preprocessing stage. For example, four different hierarchical threshold values for embedding similarity may be defined. A disjoint set union-find operation may be run to merge similar tracklets that may have been split. A cleanup operation may be performed, where noisy ids are removed, leaving final tracked detections (e.g., components and/or contents of the location that appear throughout the frames of video data).

These tracked detections facilitate grouping component and/or content identities across frames of a video. For example, each component and/or content may have a group of 2D detections associated with it that may be back projected in 3D using depth maps and camera poses for their respective frames. The different viewpoints and corresponding detection boxes for a given component and/or content are fused to create a unified 3D representation. As new detections are tracked and fused, bounds and rotation of a 3D bounding box bounding the content and/or component are updated accordingly to grow or shrink based on available data.

Informed by the object class, reference block module 120 (e.g., if present) may apply certain man-made priors. For example, reference block module 120 may require a side of a 3D bounding box to be coplanar to a wall or the floor, or enforce certain content relationships such as a chair and dining table being closer together than a bed and dining table.

In some embodiments, the video data of the location is received room by room and used to reconstruct multiple rooms in a common coordinate space. System 100 is configured to reconstruct multiple rooms (e.g., on the same floor of a location) and ensure that they are consistent across the common coordinate space, even though the scanning process may proceed room-by-room (e.g., to limit user's fatigue and/or for other reasons). This means that after scanning an entire floor of rooms, for example, the user still obtains a faithful virtual representation of the location.

As described above, the 3D model and/or the virtual representation may include all of the rooms on at least one floor of the location. To facilitate room by room scanning of the location, for example, inside/outside module 122 may be configured to determine whether a user has exited a scanned room at the location, and then (optionally) prompt the user to continue scanning the next room.

Inside/outside module 122 may be configured such that, responsive to the conclusion of a scan of the room, a bounding rectangle R is determined (along X and Y axes) based on generated surfels. The bounding rectangle R may be divided into square and/or other shaped bins (bin dimensions may be an implementation dependent variable), where surfel normals that fall into each bin are accumulated. Bin sizes reflect a discretization of the space at some metric scale. These bin sizes are chosen empirically. An average normal vector n for each bin may be determined, and per-bin segments may be determined for bins that accumulated more than a threshold number of k surfels (the threshold number of k surfels may also be an implementation dependent variable). The purpose of the threshold is to limit the impact of outlier or noisy surfels on a determination of the bounds of a room. A vector t orthogonal to the average normal vector n may be determined by inside/outside module 122, along with a bin center c and segment endpoints a and b at predefined distances d from the bin center (on opposite sides of the bin center). Segment endpoints a and b may be determined as: a=c+dt and b=c−dt. The predefined distances d are related to the bin dimensions and/or other factors. For example, the predefined distances may be determined empirically as an implementation decision based on performance of room bound estimation and/or other information. These are also tunable parameters. A current user location comprising a query point q is determined (e.g., based on data from a location sensor in the user's smartphone, based on ongoing construction of the 3D model and/or virtual representation, and/or other factors). The user is determined to be outside a (previously scanned) room if the query point q is outside of the bounding rectangle R, or per-bin segments are used to determine generalized a winding number, which is used as an indicator of whether the user is inside or outside the room (e.g., as described in the paper by Alec Jacobson, Ladislav Kavan, Olga Sorkine-Hornung. “Robust Inside-Outside Segmentation using Generalized Winding Numbers.” ACM Transaction on Graphics 32(4) [Proceedings of SIGGRAPH], 2013). Inside/outside module 122 may be configured to prompt the user to start scanning a new room responsive to a determination that a user has exited the room, for example.

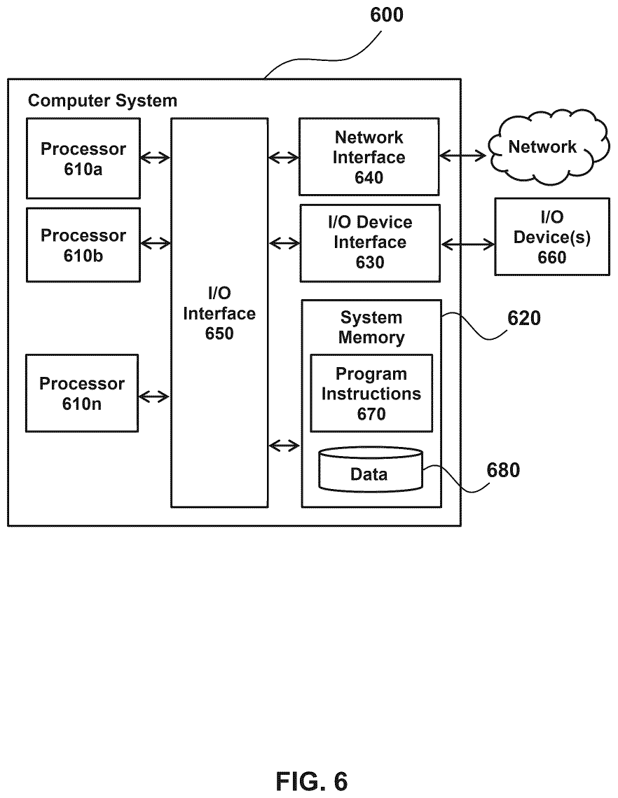

FIG. 6 is a diagram that illustrates an exemplary computer system 600 in accordance with embodiments of the present system (e.g., a hand-held computing device such as a smartphone). Various portions of systems, methods, and/or software described herein may include or be executed on one or more computer systems the same as or similar to computer system 600. Computer system 600 in FIG. 6 may be an alternate illustration of hand-held computing device 102 shown in FIG. 1. For example, hand-held computing device 102 and computer system 600 may be the same device (e.g., a smartphone). The processor shown in FIG. 1, and the processor(s) described as part of computer system 600 may be the same, as may also be true for corresponding illustrations of electronic storage, a user interface, etc. In addition, one or more of the modules of system 100 (FIG. 1) may be, include, and/or be executed by one more computer systems the same as or similar to computer system 600. Further, processes, modules, processor components, and/or other components of system 100 described herein may be executed by one or more processing systems similar to and/or the same as that of computer system 600.

Computer system 600 may include one or more processors (e.g., processors 610a-610n) coupled to system memory 620, an input/output I/O device interface 630, and a network interface 640 via an input/output (I/O) interface 650. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computer system 600. A processor may execute code (e.g., machine readable instructions, processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 620). Computer system 600 may be a uni-processor system including one processor (e.g., processor 610a), or a multi-processor system including any number of suitable processors (e.g., 610a-610n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computer system 600 may include a plurality of computing devices (e.g., distributed computer systems) to implement various processing functions.

I/O device interface 630 may provide an interface for connection of one or more I/O devices 660 to computer system 600. I/O devices may include devices that receive input (e.g., from a user) or output information (e.g., to a user). I/O devices 660 may include, for example, graphical user interface presented on displays (e.g., a touch screen or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 660 may be part of computer system 600 and/or be connected to computer system 600 through a wired or wireless connection. I/O devices 660 may be connected to computer system 600 from a remote location. I/O devices 660 located on a remote computer system, for example, may be connected to computer system 600 via a network and network interface 640.

Network interface 640 may include a network adapter that provides for connection of computer system 600 to a network. Network interface may 640 may facilitate data exchange between computer system 600 and other devices connected to the network. Network interface 640 may support wired or wireless communication. The network may include an electronic communication network, such as the Internet, a local area network (LAN), a wide area network (WAN), a cellular communications network, or the like.

System memory 620 may be configured to store program instructions 670 or data 680. Software such as program instructions 670 (machine readable instructions) may be executable by a processor (e.g., one or more of processors 610a-610n) to implement one or more embodiments of the present techniques. Instructions 670 may include modules and/or components (e.g., the modules shown in FIG. 1) of computer program instructions for implementing one or more techniques described herein with regard to various processing modules and/or components. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 620 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 620 may include a non-transitory computer readable storage medium that may have program instructions stored thereon that are executable by a computer processor (e.g., one or more of processors 610a-610n) to cause the subject matter and the functional operations described herein. A memory (e.g., system memory 620) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times, e.g., a copy may be created by writing program code to a first-in-first-out buffer in a network interface, where some of the instructions are pushed out of the buffer before other portions of the instructions are written to the buffer, with all of the instructions residing in memory on the buffer, just not all at the same time.

I/O interface 650 may be configured to coordinate I/O traffic between processors 610a-610n, system memory 620, network interface 640, I/O devices 660, and/or other peripheral devices. I/O interface 650 may perform protocol, timing, or other data transformations to convert data signals from one component (e.g., system memory 620) into a format suitable for use by another component (e.g., processors 610a-610n). I/O interface 650 may include support for devices attached through various types of peripheral buses, such as a variant of the Peripheral Component Interconnect (PCI) bus standard or the Universal Serial Bus (USB or USB-C) standard.

Those skilled in the art will appreciate that computer system 600 is merely illustrative and is not intended to limit the scope of the techniques described herein. Computer system 600 may include any combination of devices or software that may perform or otherwise provide for the performance of the techniques described herein. For example, computer system 600 may include or be a combination of a cloud-computing system, a smartphone, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, a television or device connected to a television (e.g., Apple TV™), or a Global Positioning System (GPS), or the like. Computer system 600 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 600 may be transmitted to computer system 600 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present invention may be practiced with other computer system configurations.

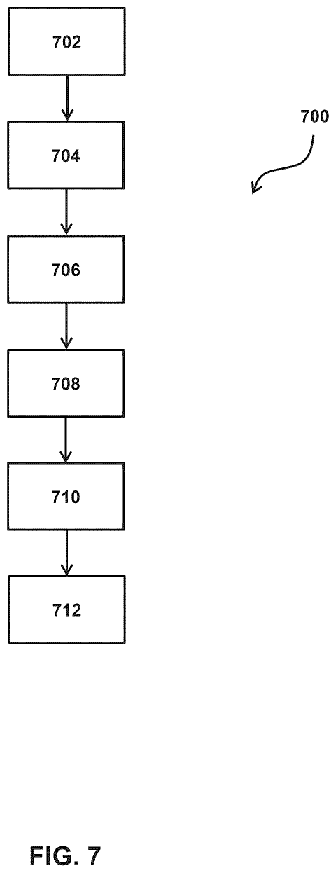

FIG. 7 is a flowchart of a resource efficient computing method 700 configured to run on a camera enabled hand-held computing device (e.g., such as a smartphone). The method is configured to be used to determine geometry, semantic information, and/or other data for a virtual representation of a location in real time with spatially localized information of elements within the location being embedded in the virtual representation. Method 700 may be performed with system 100 (FIG. 1), computer system 600 (FIG. 6), and/or other components discussed above.

Method 700 includes receiving (operation 702) video data of a location. The video data is generated via a camera and comprises a plurality of successive frames. Method 700 includes determining (operation 704), with a depth estimation module (e.g., as described above, depth information for each of the plurality of successive frames of the video data. Method 700 includes aggregating (operation 706), with a reconstruction and rendering module (as described above), using surfels, the depth information for each of the plurality of successive frames of video data to generate a 3-dimensional (3D) model of the location and contents therein. In some embodiments, method 700 may include determining (operation 708), with a segmentation module (as described above), semantic information about the location based on the video data. The semantic information may indicate presence and/or location of components and/or contents of the location. Method 700 includes generating (operation 710) a virtual representation of the location. This may be based on the 3D model, the semantic information (e.g., if it exists), and/or other information. In some embodiments, this may be accomplished by annotating the 3D model with spatially localized data associated with the location.

Method 700 includes receiving the video data of the location room by room and reconstructing multiple rooms at the location in a common coordinate space (e.g., by determining whether a user has left a room and scanned the next room (operation 712), as described above). This may be accomplished by determining a bounding rectangle based on generated surfels, and dividing the bounding rectangle into square bins where surfel normals that fall into each bin are accumulated. An average normal vector for each bin is determined with bin dimensions being an implementation dependent variable. Per-bin segments are determined for bins that accumulated more than a threshold number of surfels, where the threshold number of surfels is also an implementation dependent variable. A vector orthogonal to the average normal vector is determined, a bin center is determined, segment endpoints at predefined distances from the bin center are determined on opposite sides of the bin center (where the predefined distances are related to the bin dimensions), and a current user location comprising a query point is determined. The user is determined to be outside the room if the query point is outside of the bounding rectangle, or per-bin segments are used to determine generalized a winding number, which is used as an indicator of whether the user is inside or outside the room. The virtual representation is updated as the user scans room to room.

In some embodiments, method 700 includes detecting planes from (large) planar regions in a depth map provided through depth estimation and/or direct sensor measurement, merging new plane detections into the 3D model in real time, and/or using plane information to impose heuristics about location shapes to enhance the 3D model, and/or for other purposes (e.g., as described above). In some embodiments, method 700 includes generating a floor plan for the location based on the 3D model and/or other information.

Method 700 may include additional operations that are not described, and/or may not include one or more of the operations described. The operations of method 700 may be performed in any order that facilitates determine geometry and semantic information for a virtual representation of a location in real time on a camera enabled hand-held computing device, as described herein.

In block diagrams, illustrated modules are depicted as discrete functional blocks, but embodiments are not limited to systems in which the functionality described herein is organized as illustrated. The functionality provided by each of the modules may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several inventions. Rather than separating those inventions into multiple isolated patent applications, applicants have grouped these inventions into a single document because their related subject matter lends itself to economies in the application process. But the distinct advantages and aspects of such inventions should not be conflated. In some cases, embodiments address all of the deficiencies noted herein, but it should be understood that the inventions are independently useful, and some embodiments address only a subset of such problems or offer other, unmentioned benefits that will be apparent to those of skill in the art reviewing the present disclosure. Due to cost constraints, some inventions disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such inventions or all aspects of such inventions.

It should be understood that the description and the drawings are not intended to limit the invention to the particular form disclosed, but to the contrary, the intention is to cover all modifications, equivalents, and alternatives falling within the spirit and scope of the present invention as defined by the appended claims. Further modifications and alternative embodiments of various aspects of the invention will be apparent to those skilled in the art in view of this description. Accordingly, this description and the drawings are to be construed as illustrative only and are for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

Various embodiments of the present systems and methods are disclosed in the subsequent list of numbered clauses. In the following, further features, characteristics, and exemplary technical solutions of the present disclosure will be described in terms of clauses that may be optionally claimed in any combination.

1. A resource efficient computing system configured to run on a camera enabled hand-held computing device, the system configured to determine geometry and semantic information for a virtual representation of a location in real time with spatially localized information of elements within the location being embedded in the virtual representation, the system comprising machine-readable instructions configured to be executed by one or more hardware processors to: receive video data of the location, the video data being generated via a camera, the video data comprising a plurality of successive frames; determine, with a depth estimation module, depth information for each of the plurality of successive frames of the video data; aggregate, with a reconstruction and rendering module, using surfels, the depth information for each of the plurality of successive frames of video data to generate a 3-dimensional (3D) model of the location; render, with the reconstruction and rendering module, the 3D model in real time for display on the hand-held computing device; and generate, based on the 3D model, a virtual representation of the location by annotating the 3D model with spatially localized data associated with the location.
2. The system of clause 1, wherein the 3D model comprises components of the location, the components of the location comprising one or more rooms, a layout, walls, doors, windows, ceilings, openings, and/or floors.
3. The system of any of the previous clauses, wherein the 3D model comprises contents of the location, the contents of the location comprising furniture, wall hangings, personal items, and/or appliances.
4. The system of any of the previous clauses, wherein the spatially localized data comprises dimensional information associated with the components and/or contents of the location; color information associated with the components and/or contents of the location; geometric properties of the components and/or contents of the location; a condition of the components and/or contents of the location; audio, visual, or natural language notes; and/or metadata associated with the components and/or contents of the location.
5. The system of any of the previous clauses, wherein the depth estimation module is configured to determine the depth information for each of the plurality of successive frames of the video data at a rate sufficient for real time virtual representation generation.
6. The system of any of the previous clauses, wherein the depth estimation module is configured to use minimally sufficient computing resources, using cost volume stereo depth estimation and one or more convolution neural networks (CNNs) to estimate full frame metric depth, wherein: a cost volume is constructed using a set of reference keyframes that are selected based on a relative pose metric to select useful nearby images in the plurality of successive frames of the video data; a rolling buffer of reference keyframes is maintained in memory, with a number of the reference frames used for constructing the cost volume being variable and/or dynamic; the cost volume is determined using a parallel algorithm; an input image and the cost volume are passed through a CNN to produce dense metric depth; and the CNN uses an efficiently parameterized backbone for real time inference.
7. The system of any of the previous clauses, wherein the cost volume is a 3D volume that indicates cost for a given voxel at a specific depth in terms of energy minimization or maximization, a cost at each voxel is determined for potentially multiple images in the plurality of successive frames, and a sum is used as a final cost volume.
8. The system of any of the previous clauses, wherein the rolling buffer of reference keyframes is maintained in memory as the video data of the location is received, and each keyframe comprises information needed for downstream processing including an original image, features extracted from the efficiently parameterized CNN backbone, a camera pose, camera intrinsics, a frame identification, and/or a keyframe identification; and wherein: each incoming frame is compared to previous keyframes in the buffer to determine if there has been sufficient motion to necessitate a new keyframe; a relative translation and orientation of each incoming frame and an immediately previous keyframe is determined and used to determine a combined pose distance; and a new keyframe is added to the buffer if the combined pose distance breaches a threshold value.
9. The system of any of the previous clauses, wherein: for each reference keyframe used to construct the cost volume, a combined pose distance is determined as a function of relative translation and rotation between an incoming frame and a reference keyframe; a list of frames that satisfy sufficient motion constraints are obtained; the listed is ordered based on camera translation and rotation; a number of reference keyframes is extracted from the ordered list; and for each reference keyframe, a cost volume is determined relative to an incoming frame and cost volumes are summed to produce the final cost volume.
10. The system of any of the previous clauses, wherein the depth information is determined by providing an input image frame and the cost volume to the CNN, which outputs a dense metric depth map, the CNN comprising the efficiently parameterized backbone, and skip connections.
11. The system of any of the previous clauses, wherein the CNN is trained on a large dataset of indoor room scans using a variety of geometric loss functions on ground truth depth measurements.
12. The system of any of the previous clauses, wherein the depth estimation module is further configured to determine a depth map comprising multiple depth values for each pixel representing visible and occluded surfaces along a camera ray.
13. The system of any of the previous clauses, wherein the reconstruction and rendering module is configured to utilize a triangle rasterization pipeline compatible with hardware available on the hand-held computing device to generate the 3D model of the location and contents therein; and wherein, for each surfel, the reconstruction and rendering module is configured to generate a canonical triangle, and use associated data to place a surfel in three dimensional space.
14. The system of any of the previous clauses, wherein the reconstruction and rendering module is configured such that newly received video data is continuously fused with the 3D model by: generating new corresponding surfels; fusing the new corresponding surfels with existing surfels; and removing existing surfels heuristically.
15. The system of any of the previous clauses, wherein the machine-readable instructions are further configured to cause the one or more hardware processors to determine, with a segmentation module, semantic information about the location based on the video data, the semantic information indicating presence and/or location of components and/or contents of the location, wherein the virtual representation is generated based on the 3D model and the semantic information.
16. The system of any of the previous clauses, wherein the segmentation module is configured to identify components and/or contents of the location by a semantically trained machine learning model, the semantically trained machine learning model configured to perform semantic or instance segmentation and/or 3D object detection and localization of each object in an input frame of the video data.
17. The system of any of the previous clauses, wherein the semantically trained machine learning model comprises a neural network configured to perform two dimensional (2D) segmentation for frames in the video data.
18. The system of any of the previous clauses, wherein the neural network comprises a feature extractor configured to use minimally sufficient computing resources on the hand-held computing device and a Feature Pyramid Network-based decoder.
19. The system of any of the previous clauses, wherein: the segmentation module is configured to determine a 3D segmented mesh using the 2D segmentation by associating a semantic class of pixels in the frames of video data to respective surfels by back-projecting the pixels to surfels using a camera pose matrix; the frames of the video data are streaming in real time; based on hardware of the hand-held computing device, neural network prediction frequency is dynamically adjusted to manage a load on the one or more hardware processors; as the 2D segmentation is occurring in real time, semantic classes of surfels coming from consecutive 2D segmentations are aggregated; and a most frequently occurring class is determined to be a surfel class.
20. The system of any of the previous clauses, further comprising using a plane module to generate the 3D model, the plane module configured to: detect planes from planar regions in a depth map provided through depth estimation and/or direct sensor measurement; merge new plane detections into the 3D model in real time; use plane information to impose heuristics about location shapes to enhance the 3D model; use planar surfaces to enhance pose accuracy; use planes to estimate geometry of relatively distant or difficult surfaces to detect at the location; and/or use bounded plane estimates determined from each frame in the video data to grow
21. The system of any of the previous clauses, further comprising instructions to generate, with a floor plan module, a floor plan of the location using lines in the 3D model, the lines determined based on a bird's eye view projection of a reconstructed 3D semantic point cloud.
22. The system of any of the previous clauses, wherein: the 3D semantic point cloud is reconstructed using a class-wise point density map of a bird's eye view mesh, generated by axis-aligning the mesh with a floor plane normal, orthogonally projecting the mesh from a top of the mesh, translating and scaling the point cloud, and determining a density map for the point cloud by slicing the point cloud at different Z values; different floor instances are determined based on the density map; and boundary points are determined based on the different floor instances, which are used to determine line segments defining the floor plan.
23. The system of any of the previous clauses, further comprising instructions to apply a detection model to each frame in the video data during a scan, wherein output at each frame comprises a set of 2D labeled bounding boxes for each frame, and wherein these detections are matched across frames using a tracking module based on camera poses and feature tracking to form tracks for each content of the location, thereby grouping detections of the same content from multiple views into a single set of detections, wherein different viewpoints and corresponding detection boxes for the same content are fused to create a unified 3D representation.
24. The system of any of the previous clauses, wherein the video data is captured by a mobile computing device associated with a user and transmitted to the one or more hardware processors without user interaction.
25. The system of any of the previous clauses, wherein receiving the video data of the location comprises receiving a real time video stream of the location.
26. The system of any of the previous clauses, wherein generating the virtual representation comprises generating or updating the 3D model based on the real time video stream of the location.
27. The system of any of the previous clauses, wherein the video data of the location is received room by room and used to reconstruct multiple rooms in a common coordinate space, and wherein the 3D model and the virtual representation of the location include all rooms on a least one floor of the location.
28. The system of any of the previous clauses, further comprising instructions to determine whether a user has exited a room.
29. The system of any of the previous clauses, wherein the instructions for determining whether a user has exited the room are configured such that, responsive to conclusion of a scan of the room: a bounding rectangle is determined based on generated surfels, the bounding rectangle is divided into square bins and surfel normals that fall into each bin are accumulated, wherein an average normal vector for each bin is determined and bin dimensions are an implementation dependent variable, per-bin segments are determined for bins that accumulated more than a threshold number of surfels, where the threshold number of surfels is an implementation dependent variable, a vector orthogonal to the average normal vector is determined, a bin center is determined, segment endpoints at predefined distances from the bin center are determined on opposite sides of the bin center, wherein the predefined distances are related to the bin dimensions, and a current user location comprising a query point is determined.
30. The system of any of the previous clauses, wherein the instructions are configured such that the user is determined to be outside the room if the query point is outside of the bounding rectangle, or per-bin segments are used to determine generalized a winding number, which is used as an indicator of whether the user is inside or outside the room.
31. The system of any of the previous clauses, further comprising instructions configured to prompt the user to start scanning a new room responsive to a determination that a user has exited the room.
32. A non-transitory machine-readable medium storing instructions which, when executed by at least one programmable processor, cause the at least one programmable processor to perform one or more operations comprising: receiving video data of a location, the video data being generated via a camera, the video data comprising a plurality of successive frames; determining, with a depth estimation module, depth information for each of the plurality of successive frames of the video data; aggregating, with a reconstruction and rendering module, using surfels, the depth information for each of the plurality of successive frames of video data to generate a 3-dimensional (3D) model of the location; rendering, with the reconstruction and rendering module, the 3D model in real time for display; and generating, based on the 3D model, a virtual representation of the location by annotating the 3D model with spatially localized data associated with the location.
33. The medium of clause 32, wherein the 3D model comprises components of the location, the components of the location comprising one or more rooms, a layout, walls, doors, windows, ceilings, openings, and/or floors.
34. The medium of any of the previous clauses, wherein the 3D model comprises contents of the location, the contents of the location comprising furniture, wall hangings, personal items, and/or appliances.
35. The medium of any of the previous clauses, wherein the spatially localized data comprises dimensional information associated with the components and/or contents of the location; color information associated with the components and/or contents of the location; geometric properties of the components and/or contents of the location; a condition of the components and/or contents of the location; audio, visual, or natural language notes; and/or metadata associated with the components and/or contents of the location.
36. The medium of any of the previous clauses, wherein the depth estimation module is configured to determine the depth information for each of the plurality of successive frames of the video data at a rate sufficient for real time virtual representation generation.
37. The medium of any of the previous clauses, wherein the depth estimation module is configured to use minimally sufficient computing resources, using cost volume stereo depth estimation and one or more convolution neural networks (CNNs) to estimate full frame metric depth, wherein: a cost volume is constructed using a set of reference keyframes that are selected based on a relative pose metric to select useful nearby images in the plurality of successive frames of the video data; a rolling buffer of reference keyframes is maintained in memory, with a number of the reference frames used for constructing the cost volume being variable and/or dynamic; the cost volume is determined using a parallel algorithm; an input image and the cost volume are passed through a CNN to produce dense metric depth; and the CNN uses an efficiently parameterized backbone for real time inference.
38. The medium of any of the previous clauses, wherein the cost volume is a 3D volume that indicates cost for a given voxel at a specific depth in terms of energy minimization or maximization, a cost at each voxel is determined for potentially multiple images in the plurality of successive frames, and a sum is used as a final cost volume.
39. The medium of any of the previous clauses, wherein the rolling buffer of reference keyframes is maintained in memory as the video data of the location is received, and each keyframe comprises information needed for downstream processing including an original image, features extracted from the efficiently parameterized CNN backbone, a camera pose, camera intrinsics, a frame identification, and/or a keyframe identification; and wherein: each incoming frame is compared to previous keyframes in the buffer to determine if there has been sufficient motion to necessitate a new keyframe; a relative translation and orientation of each incoming frame and an immediately previous keyframe is determined and used to determine a combined pose distance; and a new keyframe is added to the buffer if the combined pose distance breaches a threshold value.
40. The medium of any of the previous clauses, wherein: for each reference keyframe used to construct the cost volume, a combined pose distance is determined as a function of relative translation and rotation between an incoming frame and a reference keyframe; a list of frames that satisfy sufficient motion constraints are obtained; the listed is ordered based on camera translation and rotation; a number of reference keyframes is extracted from the ordered list; and for each reference keyframe, a cost volume is determined relative to an incoming frame and cost volumes are summed to produce the final cost volume.
41. The medium of any of the previous clauses, wherein the depth information is determined by providing an input image frame and the cost volume to the CNN, which outputs a dense metric depth map, the CNN comprising the efficiently parameterized backbone, and skip connections.
42. The medium of any of the previous clauses, wherein the CNN is trained on a large dataset of indoor room scans using a variety of geometric loss functions on ground truth depth measurements.
43. The medium of any of the previous clauses, wherein the depth estimation module is further configured to determine a depth map comprising multiple depth values for each pixel representing visible and occluded surfaces along a camera ray.
44. The medium of any of the previous clauses, wherein the reconstruction and rendering module is configured to utilize a triangle rasterization pipeline compatible with hardware available on the hand-held computing device to generate the 3D model of the location and contents therein; and wherein, for each surfel, the reconstruction and rendering module is configured to generate a canonical triangle, and use associated data to place a surfel in three dimensional space.
45. The medium of any of the previous clauses, wherein the reconstruction and rendering module is configured such that newly received video data is continuously fused with the 3D model by: generating new corresponding surfels; fusing the new corresponding surfels with existing surfels; and removing existing surfels heuristically.
46. The medium of any of the previous clauses, wherein the machine-readable instructions are further configured to cause the one or more hardware processors to determine, with a segmentation module, semantic information about the location based on the video data, the semantic information indicating presence and/or location of components and/or contents of the location, wherein the virtual representation is generated based on the 3D model and the semantic information.
47. The medium of any of the previous clauses, wherein the segmentation module is configured to identify components and/or contents of the location by a semantically trained machine learning model, the semantically trained machine learning model configured to perform semantic or instance segmentation and/or 3D object detection and localization of each object in an input frame of the video data.
48. The medium of any of the previous clauses, wherein the semantically trained machine learning model comprises a neural network configured to perform two dimensional (2D) segmentation for frames in the video data.
49. The medium of any of the previous clauses, wherein the neural network comprises a feature extractor configured to use minimally sufficient computing resources on the hand-held computing device and a Feature Pyramid Network-based decoder.
50. The medium of any of the previous clauses, wherein: the segmentation module is configured to determine a 3D segmented mesh using the 2D segmentation by associating a semantic class of pixels in the frames of video data to respective surfels by back-projecting the pixels to surfels using a camera pose matrix; the frames of the video data are streaming in real time; based on hardware of the hand-held computing device, neural network prediction frequency is dynamically adjusted to manage a load on the one or more hardware processors; as the 2D segmentation is occurring in real time, semantic classes of surfels coming from consecutive 2D segmentations are aggregated; and a most frequently occurring class is determined to be a surfel class.
51. The medium of any of the previous clauses, further comprising using a plane module to generate the 3D model, the plane module configured to: detect planes from planar regions in a depth map provided through depth estimation and/or direct sensor measurement; merge new plane detections into the 3D model in real time; use plane information to impose heuristics about location shapes to enhance the 3D model; use planar surfaces to enhance pose accuracy; use planes to estimate geometry of relatively distant or difficult surfaces to detect at the location; and/or use bounded plane estimates determined from each frame in the video data to grow
52. The medium of any of the previous clauses, further comprising instructions to generate, with a floor plan module, a floor plan of the location using lines in the 3D model, the lines determined based on a bird's eye view projection of a reconstructed 3D semantic point cloud.
53. The medium of any of the previous clauses, wherein: the 3D semantic point cloud is reconstructed using a class-wise point density map of a bird's eye view mesh, generated by axis-aligning the mesh with a floor plane normal, orthogonally projecting the mesh from a top of the mesh, translating and scaling the point cloud, and determining a density map for the point cloud by slicing the point cloud at different Z values; different floor instances are determined based on the density map; and boundary points are determined based on the different floor instances, which are used to determine line segments defining the floor plan.
54. The medium of any of the previous clauses, further comprising instructions to apply a detection model to each frame in the video data during a scan, wherein output at each frame comprises a set of 2D labeled bounding boxes for each frame, and wherein these detections are matched across frames using a tracking module based on camera poses and feature tracking to form tracks for each content of the location, thereby grouping detections of the same content from multiple views into a single set of detections, wherein different viewpoints and corresponding detection boxes for the same content are fused to create a unified 3D representation.
55. The medium of any of the previous clauses, wherein the video data is captured by a mobile computing device associated with a user and transmitted to the one or more hardware processors without user interaction.
56. The medium of any of the previous clauses, wherein receiving the video data of the location comprises receiving a real time video stream of the location.
57. The medium of any of the previous clauses, wherein generating the virtual representation comprises generating or updating the 3D model based on the real time video stream of the location.
58. The medium of any of the previous clauses, wherein the video data of the location is received room by room and used to reconstruct multiple rooms in a common coordinate space, and wherein the 3D model and the virtual representation of the location include all rooms on a least one floor of the location.
59. The medium of any of the previous clauses, further comprising instructions to determine whether a user has exited a room.
60. The medium of any of the previous clauses, wherein the instructions for determining whether a user has exited the room are configured such that, responsive to conclusion of a scan of the room: a bounding rectangle is determined based on generated surfels, the bounding rectangle is divided into square bins and surfel normals that fall into each bin are accumulated, wherein an average normal vector for each bin is determined and bin dimensions are an implementation dependent variable, per-bin segments are determined for bins that accumulated more than a threshold number of surfels, where the threshold number of surfels is an implementation dependent variable, a vector orthogonal to the average normal vector is determined, a bin center is determined, segment endpoints at predefined distances from the bin center are determined on opposite sides of the bin center, wherein the predefined distances are related to the bin dimensions, and a current user location comprising a query point is determined.
61. The medium of any of the previous clauses, wherein the instructions are configured such that the user is determined to be outside the room if the query point is outside of the bounding rectangle, or per-bin segments are used to determine generalized a winding number, which is used as an indicator of whether the user is inside or outside the room.
62. The medium of any of the previous clauses, further comprising instructions configured to prompt the user to start scanning a new room responsive to a determination that a user has exited the room.
63. A method for determining geometry and semantic information for a virtual representation of a location in real time with spatially localized information of elements within the location being embedded in the virtual representation, the method comprising: receiving video data of a location, the video data being generated via a camera, the video data comprising a plurality of successive frames; determining, with a depth estimation module, depth information for each of the plurality of successive frames of the video data; aggregating, with a reconstruction and rendering module, using surfels, the depth information for each of the plurality of successive frames of video data to generate a 3-dimensional (3D) model of the location; rendering, with the reconstruction and rendering module, the 3D model in real time for display; and generating, based on the 3D model, a virtual representation of the location by annotating the 3D model with spatially localized data associated with the location.
64. The method of clause 63, wherein the 3D model comprises components of the location, the components of the location comprising one or more rooms, a layout, walls, doors, windows, ceilings, openings, and/or floors.
65. The method of any of the previous clauses, wherein the 3D model comprises contents of the location, the contents of the location comprising furniture, wall hangings, personal items, and/or appliances.
66. The method of any of the previous clauses, wherein the spatially localized data comprises dimensional information associated with the components and/or contents of the location; color information associated with the components and/or contents of the location; geometric properties of the components and/or contents of the location; a condition of the components and/or contents of the location; audio, visual, or natural language notes; and/or metadata associated with the components and/or contents of the location.
67. The method of any of the previous clauses, wherein the depth estimation module is configured to determine the depth information for each of the plurality of successive frames of the video data at a rate sufficient for real time virtual representation generation.
68. The method of any of the previous clauses, wherein the depth estimation module is configured to use minimally sufficient computing resources, using cost volume stereo depth estimation and one or more convolution neural networks (CNNs) to estimate full frame metric depth, wherein: a cost volume is constructed using a set of reference keyframes that are selected based on a relative pose metric to select useful nearby images in the plurality of successive frames of the video data; a rolling buffer of reference keyframes is maintained in memory, with a number of the reference frames used for constructing the cost volume being variable and/or dynamic; the cost volume is determined using a parallel algorithm; an input image and the cost volume are passed through a CNN to produce dense metric depth; and the CNN uses an efficiently parameterized backbone for real time inference.
69. The method of any of the previous clauses, wherein the cost volume is a 3D volume that indicates cost for a given voxel at a specific depth in terms of energy minimization or maximization, a cost at each voxel is determined for potentially multiple images in the plurality of successive frames, and a sum is used as a final cost volume.
70. The method of any of the previous clauses, wherein the rolling buffer of reference keyframes is maintained in memory as the video data of the location is received, and each keyframe comprises information needed for downstream processing including an original image, features extracted from the efficiently parameterized CNN backbone, a camera pose, camera intrinsics, a frame identification, and/or a keyframe identification; and wherein: each incoming frame is compared to previous keyframes in the buffer to determine if there has been sufficient motion to necessitate a new keyframe; a relative translation and orientation of each incoming frame and an immediately previous keyframe is determined and used to determine a combined pose distance; and a new keyframe is added to the buffer if the combined pose distance breaches a threshold value.
71. The method of any of the previous clauses, wherein: for each reference keyframe used to construct the cost volume, a combined pose distance is determined as a function of relative translation and rotation between an incoming frame and a reference keyframe; a list of frames that satisfy sufficient motion constraints are obtained; the listed is ordered based on camera translation and rotation; a number of reference keyframes is extracted from the ordered list; and for each reference keyframe, a cost volume is determined relative to an incoming frame and cost volumes are summed to produce the final cost volume.
72. The method of any of the previous clauses, wherein the depth information is determined by providing an input image frame and the cost volume to the CNN, which outputs a dense metric depth map, the CNN comprising the efficiently parameterized backbone, and skip connections.
73. The method of any of the previous clauses, wherein the CNN is trained on a large dataset of indoor room scans using a variety of geometric loss functions on ground truth depth measurements.
74. The method of any of the previous clauses, wherein the depth estimation module is further configured to determine a depth map comprising multiple depth values for each pixel representing visible and occluded surfaces along a camera ray.
75. The method of any of the previous clauses, wherein the reconstruction and rendering module is configured to utilize a triangle rasterization pipeline compatible with hardware available on the hand-held computing device to generate the 3D model of the location and contents therein; and wherein, for each surfel, the reconstruction and rendering module is configured to generate a canonical triangle, and use associated data to place a surfel in three dimensional space.
76. The method of any of the previous clauses, wherein the reconstruction and rendering module is configured such that newly received video data is continuously fused with the 3D model by: generating new corresponding surfels; fusing the new corresponding surfels with existing surfels; and removing existing surfels heuristically.
77. The method of any of the previous clauses, wherein the machine-readable instructions are further configured to cause the one or more hardware processors to determine, with a segmentation module, semantic information about the location based on the video data, the semantic information indicating presence and/or location of components and/or contents of the location, wherein the virtual representation is generated based on the 3D model and the semantic information.
78. The method of any of the previous clauses, wherein the segmentation module is configured to identify components and/or contents of the location by a semantically trained machine learning model, the semantically trained machine learning model configured to perform semantic or instance segmentation and/or 3D object detection and localization of each object in an input frame of the video data.
79. The method of any of the previous clauses, wherein the semantically trained machine learning model comprises a neural network configured to perform two dimensional (2D) segmentation for frames in the video data.
80. The method of any of the previous clauses, wherein the neural network comprises a feature extractor configured to use minimally sufficient computing resources on the hand-held computing device and a Feature Pyramid Network-based decoder.
81. The method of any of the previous clauses, wherein: the segmentation module is configured to determine a 3D segmented mesh using the 2D segmentation by associating a semantic class of pixels in the frames of video data to respective surfels by back-projecting the pixels to surfels using a camera pose matrix; the frames of the video data are streaming in real time; based on hardware of the hand-held computing device, neural network prediction frequency is dynamically adjusted to manage a load on the one or more hardware processors; as the 2D segmentation is occurring in real time, semantic classes of surfels coming from consecutive 2D segmentations are aggregated; and a most frequently occurring class is determined to be a surfel class.
82. The method of any of the previous clauses, further comprising using a plane module to generate the 3D model, the plane module configured to: detect planes from planar regions in a depth map provided through depth estimation and/or direct sensor measurement; merge new plane detections into the 3D model in real time; use plane information to impose heuristics about location shapes to enhance the 3D model; use planar surfaces to enhance pose accuracy; use planes to estimate geometry of relatively distant or difficult surfaces to detect at the location; and/or use bounded plane estimates determined from each frame in the video data to grow location boundary surfaces in real time.
83. The method of any of the previous clauses, further comprising instructions to generate, with a floor plan module, a floor plan of the location using lines in the 3D model, the lines determined based on a bird's eye view projection of a reconstructed 3D semantic point cloud.
84. The method of any of the previous clauses, wherein: the 3D semantic point cloud is reconstructed using a class-wise point density map of a bird's eye view mesh, generated by axis-aligning the mesh with a floor plane normal, orthogonally projecting the mesh from a top of the mesh, translating and scaling the point cloud, and determining a density map for the point cloud by slicing the point cloud at different Z values; different floor instances are determined based on the density map; and boundary points are determined based on the different floor instances, which are used to determine line segments defining the floor plan.
85. The method of any of the previous clauses, further comprising instructions to apply a detection model to each frame in the video data during a scan, wherein output at each frame comprises a set of 2D labeled bounding boxes for each frame, and wherein these detections are matched across frames using a tracking module based on camera poses and feature tracking to form tracks for each content of the location, thereby grouping detections of the same content from multiple views into a single set of detections, wherein different viewpoints and corresponding detection boxes for the same content are fused to create a unified 3D representation.
86. The method of any of the previous clauses, wherein the video data is captured by a mobile computing device associated with a user and transmitted to the one or more hardware processors without user interaction.
87. The method of any of the previous clauses, wherein receiving the video data of the location comprises receiving a real time video stream of the location.
88. The method of any of the previous clauses, wherein generating the virtual representation comprises generating or updating the 3D model based on the real time video stream of the location.
89. The method of any of the previous clauses, wherein the video data of the location is received room by room and used to reconstruct multiple rooms in a common coordinate space, and wherein the 3D model and the virtual representation of the location include all rooms on a least one floor of the location.
90. The method of any of the previous clauses, further comprising instructions to determine whether a user has exited a room.
91. The method of any of the previous clauses, wherein the instructions for determining whether a user has exited the room are configured such that, responsive to conclusion of a scan of the room: a bounding rectangle is determined based on generated surfels, the bounding rectangle is divided into square bins and surfel normals that fall into each bin are accumulated, wherein an average normal vector for each bin is determined and bin dimensions are an implementation dependent variable, per-bin segments are determined for bins that accumulated more than a threshold number of surfels, where the threshold number of surfels is an implementation dependent variable, a vector orthogonal to the average normal vector is determined, a bin center is determined, segment endpoints at predefined distances from the bin center are determined on opposite sides of the bin center, wherein the predefined distances are related to the bin dimensions, and a current user location comprising a query point is determined.
92. The method of any of the previous clauses, wherein the instructions are configured such that the user is determined to be outside the room if the query point is outside of the bounding rectangle, or per-bin segments are used to determine generalized a winding number, which is used as an indicator of whether the user is inside or outside the room.
93. The method of any of the previous clauses, further comprising instructions configured to prompt the user to start scanning a new room responsive to a determination that a user has exited the room.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device.

What is claimed is:

1. A resource efficient computing system configured to run on a camera enabled hand-held computing device, the system configured to determine geometry and semantic information for a virtual representation of a location in real time with spatially localized information of elements within the location being embedded in the virtual representation, the system comprising machine-readable instructions configured to be executed by one or more hardware processors to:
receive video data of the location, the video data being generated via a camera, the video data comprising a plurality of successive frames;
determine, with a depth estimation module, depth information for each of the plurality of successive frames of the video data;
aggregate, with a reconstruction and rendering module, using surfels, the depth information for each of the plurality of successive frames of video data to generate a 3-dimensional (3D) model of the location;
render, with the reconstruction and rendering module, the 3D model in real time for display on the hand-held computing device; and
generate, based on the 3D model, a virtual representation of the location by annotating the 3D model with spatially localized data associated with the location.

2. The system of claim 1, wherein the 3D model comprises components of the location, the components of the location comprising one or more rooms, a layout, walls, doors, windows, ceilings, openings, and/or floors.

3. The system of claim 1, wherein the 3D model comprises contents of the location, the contents of the location comprising furniture, wall hangings, personal items, and/or appliances.

4. The system of claim 1, wherein the spatially localized data comprises dimensional information associated with components and/or contents of the location; color information associated with the components and/or contents of the location; geometric properties of the components and/or contents of the location; a condition of the components and/or contents of the location; audio, visual, or natural language notes; and/or metadata associated with the components and/or contents of the location.

5. The system of claim 1, wherein the depth estimation module is configured to determine the depth information for each of the plurality of successive frames of the video data at a rate sufficient for real time virtual representation generation.

6. The system of claim 5, wherein the depth estimation module is configured to use minimally sufficient computing resources, using cost volume stereo depth estimation and one or more convolution neural networks (CNNs) to estimate full frame metric depth, wherein:
a cost volume is constructed using a set of reference keyframes that are selected based on a relative pose metric to select useful nearby images in the plurality of successive frames of the video data;
a rolling buffer of reference keyframes is maintained in memory, with a number of the reference frames used for constructing the cost volume being variable and/or dynamic;
the cost volume is determined using a parallel algorithm;
an input image and the cost volume are passed through a CNN to produce dense metric depth; and
the CNN uses an efficiently parameterized backbone for real time inference.

7. The system of claim 6, wherein the cost volume is a 3D volume that indicates cost for a given voxel at a specific depth in terms of energy minimization or maximization, a cost at each voxel is determined for potentially multiple images in the plurality of successive frames, and a sum is used as a final cost volume.

8. The system of claim 7, wherein the rolling buffer of reference keyframes is maintained in memory as the video data of the location is received, and each keyframe comprises information needed for downstream processing including an original image, features extracted from the efficiently parameterized CNN backbone, a camera pose, camera intrinsics, a frame identification, and/or a keyframe identification; and wherein:
each incoming frame is compared to previous keyframes in the buffer to determine if there has been sufficient motion to necessitate a new keyframe;
a relative translation and orientation of each incoming frame and an immediately previous keyframe is determined and used to determine a combined pose distance; and
a new keyframe is added to the buffer if the combined pose distance breaches a threshold value.

9. The system of claim 8, wherein:
for each reference keyframe used to construct the cost volume, a combined pose distance is determined as a function of relative translation and rotation between an incoming frame and a reference keyframe;
a list of frames that satisfy sufficient motion constraints are obtained;
the listed is ordered based on camera translation and rotation;
a number of reference keyframes is extracted from the ordered list; and
for each reference keyframe, a cost volume is determined relative to an incoming frame and cost volumes are summed to produce the final cost volume.

10. The system of claim 6, wherein the depth information is determined by providing an input image frame and the cost volume to the CNN, which outputs a dense metric depth map, the CNN comprising the efficiently parameterized backbone, and skip connections.

11. The system of claim 10, wherein the CNN is trained on a large dataset of indoor room scans using a variety of geometric loss functions on ground truth depth measurements.

12. The system of claim 1, wherein the reconstruction and rendering module is configured to utilize a triangle rasterization pipeline compatible with hardware available on the hand-held computing device to generate the 3D model of the location and contents therein; and wherein, for each surfel, the reconstruction and rendering module is configured to generate a canonical triangle, and use associated data to place a surfel in three dimensional space.

13. The system of claim 12, wherein the reconstruction and rendering module is configured such that newly received video data is continuously fused with the 3D model by:
generating new corresponding surfels;
fusing the new corresponding surfels with existing surfels; and
removing existing surfels heuristically.

14. The system of claim 1, wherein the video data is captured by a mobile computing device associated with a user and transmitted to the one or more hardware processors without user interaction.

15. The system of claim 1, wherein receiving the video data of the location comprises receiving a real time video stream of the location.

16. The system of claim 15, wherein generating the virtual representation comprises generating or updating the 3D model based on the real time video stream of the location.

17. The system of claim 1, wherein the video data of the location is received room by room and used to reconstruct multiple rooms in a common coordinate space, and wherein the 3D model and the virtual representation of the location include all rooms on a least one floor of the location.

18. The system of claim 17, further comprising instructions to determine whether a user has exited a room.

19. The system of claim 18, wherein the instructions for determining whether a user has exited the room are configured such that, responsive to conclusion of a scan of the room:
a bounding rectangle is determined based on generated surfels,
the bounding rectangle is divided into square bins and surfel normals that fall into each bin are accumulated, wherein an average normal vector for each bin is determined and bin dimensions are an implementation dependent variable,
per-bin segments are determined for bins that accumulated more than a threshold number of surfels, where the threshold number of surfels is an implementation dependent variable,
a vector orthogonal to the average normal vector is determined,
a bin center is determined,
segment endpoints at predefined distances from the bin center are determined on opposite sides of the bin center, wherein the predefined distances are related to the bin dimensions, and
a current user location comprising a query point is determined,
wherein the user is determined to be outside the room if the query point is outside of the bounding rectangle, or per-bin segments are used to determine generalized a winding number, which is used as an indicator of whether the user is inside or outside the room.

20. The system of claim 19, further comprising instructions configured to prompt the user to start scanning a new room responsive to a determination that a user has exited the room.
